(19) United States
(12) Patent Application Publication
(10) Pub. No.: US 2019/0351959 A1
(43) Pub. Date: Nov. 21, 2019

(54) MASTER LINK ASSEMBLY FOR AN OFFSET LINK TRACK CHAIN

(71) Applicant: Caterpillar Inc., Deerfield, IL (US)

(72) Inventor: Matthew TRONE, Pekin, IL (US)

(73) Assignee: Caterpillar Inc., Deerfield, IL (US)

(21) Appl. No.: 15/983,665

(22) Filed: May 18, 2018

(51) Int. Cl. B62D 55/21; B62D 55/32

(52) U.S. Cl. CPC B62D 55/213; B62D 55/21; B62D 55/32

(57) ABSTRACT

An offset link track chain may include a plurality of link subassemblies including a first link subassembly and a second link subassembly and a master link assembly removably coupled between the first link subassembly and the second link subassembly. Each link subassembly of the plurality of link subassemblies may include a pair of offset links coupled together. The master link assembly may include a pair of straight links. Each straight link may include a link body having (a) a first aperture positioned proximate a first end, (b) a second aperture positioned proximate a second end, and (c) a threaded fastener. Changing a relative position of the fastener with respect to the link body may change a diameter of the first and second apertures.

### TECHNICAL FIELD

The present disclosure relates generally to a master link assembly for a track chain, and more particularly, to an offset clamp master link assembly for a offset link track chain.

### BACKGROUND

Track type machines typically utilize tracks or chains on either side of the machine that are connected to surface engaging elements, known as track shoes, to move the machine. A sprocket, driven by an engine of the machine, engages and translates the chain about spaced apart pulley mechanisms. As the chain translates, the connected track shoes engage a ground surface under the machine and propel the machine on the surface. The chains are made of link assemblies coupled together. Track chains can be broadly classified as straight link track chains and offset link track chains. Straight link track chains have alternate inner and outer links that are coupled together while, in an offset link track chain, all the links are alike. Irrespective of the type of track chain used, track chains wear over time and may need to be replaced or serviced. Typically, a master link is provided in the track chain to allow for disassembly of the chain (i.e., separation of two ends of the chain).

An exemplary master link is disclosed in U.S. Pat. No. 6,783,196 (“the '196 patent”) issued to Maguire et al. The '196 patent discloses a master link assembly for a straight link chain. In the '196 patent, the master link assembly is split apart to disassemble the track chain. While the master link of the '196 patent may be suitable for some applications, it may not be suitable for other applications. The disclosed master link assembly is directed to overcoming one or more of the shortcomings set forth above and/or other shortcomings in the art. The scope of the current disclosure, however, is defined by the attached claims, and not by the ability to solve any specific problem.

### SUMMARY

In one aspect, an offset link track chain is disclosed. The offset link track chain may include a plurality of link subassemblies including a first link subassembly and a second link subassembly and a master link assembly removably coupled between the first link subassembly and the second link subassembly. Each link subassembly of the plurality of link subassemblies may include a pair of offset links coupled together. The master link assembly may include a pair of straight links. Each straight link may include a link body having (a) a first aperture positioned proximate a first end, (b) a second aperture positioned proximate a second end, and (c) a threaded fastener. Changing a relative position of the fastener with respect to the link body may change a diameter of the first and second apertures.

In another aspect, An offset link track chain is disclosed. The offset link track chain may include a plurality of link subassemblies including a first link subassembly and a second link subassembly and a master link assembly removably coupled between the first link subassembly and the second link subassembly. Each link subassembly of the plurality of link subassemblies may include a pair of offset links coupled together. The master link assembly may include a pair of straight links. Each straight link may include a link body having (a) a first aperture positioned proximate a first end, (b) a second aperture positioned proximate a second end, (c) a third aperture positioned between the first and second apertures, (d) a gap extending through the link body between the first and third apertures, and (e) a threaded fastener extending into the link body through the third aperture.

In yet another aspect, a method of fabricating an endless offset link track chain is disclosed. The method may include fixedly coupling a plurality of link subassemblies together to form an offset link track chain having a first free end and a second free end. The method may also include fixedly coupling a transition link assembly to the first free end of the offset link track chain, wherein the transition link assembly includes a pair of straight links. The method may further include removably coupling a master link assembly between the transition link assembly and the second free end of the offset link track chain to form an endless track chain. The master link assembly may include a pair of straight links.

### BRIEF DESCRIPTION OF THE DRAWINGS

FIG. 1 is a perspective view of an exemplary mobile machine having an offset link track chain;

FIGS. 2A and 2B are different views of an exemplary master link assembly of the offset link track chain of FIG. 1;

FIG. 3A is a perspective view of an exemplary bushing assembly of the offset link track chain of FIG. 1;

FIG. 3B is a perspective view of an exemplary cartridge assembly of the offset link track chain of FIG. 1; and

FIG. 4 is a perspective view of an exemplary link of the master link assembly of the offset link track chain of FIG. 1.

### DETAILED DESCRIPTION

In this disclosure, relative terms, such as, for example, “about” is used to indicate a possible variation of ±10% in a stated numeric value. It should be noted that the description set forth herein is merely illustrative in nature and is not intended to limit the embodiments of the subject matter, or the application and uses of such embodiments.

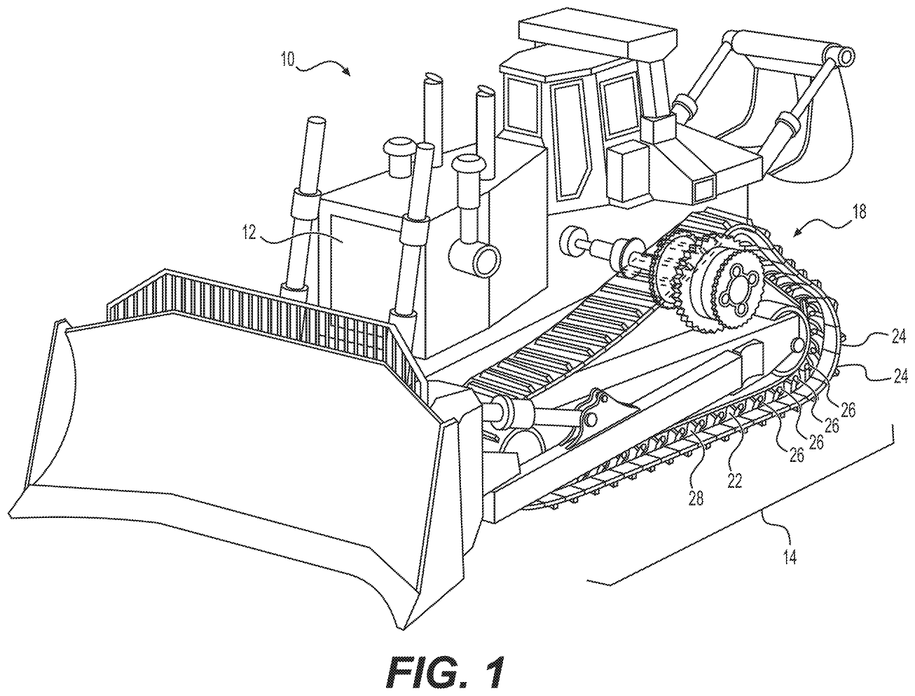

FIG. 1 illustrates an exemplary mobile machine 10 that performs some type of operation associated with an industry such as mining, construction, farming, transportation, or any other industry known in the art. For example, machine 10 may be an earth moving machine such as an excavator, a dozer, a loader, a backhoe, a motor grader, or any other earth moving machine. Machine 10 may include a power source 12 and an undercarriage assembly 14 driven by power source 12. Undercarriage assembly 14 may include two separate continuous tracks 18, one on either side of machine 10 (only one of which is shown in FIG. 1), driven by power source 12. Each track 18 includes an endless track chain 22 that forms an endless loop and a plurality of track shoes 24 configured to engage a ground surface. Track chain 22 is an offset link chain that includes multiple structurally similar link subassemblies 26 that are coupled together. Track chain 22 also includes a master link assembly 28 than enables the endless track chain 22 to be disassembled or opened to form a chain with two ends. In the discussion below, track chain 22 will be referred to as chain 22.

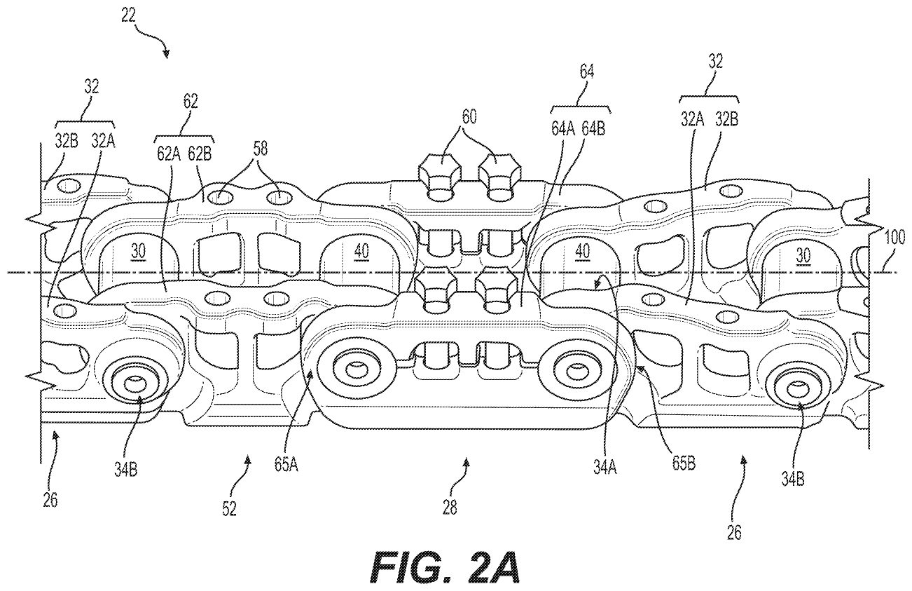

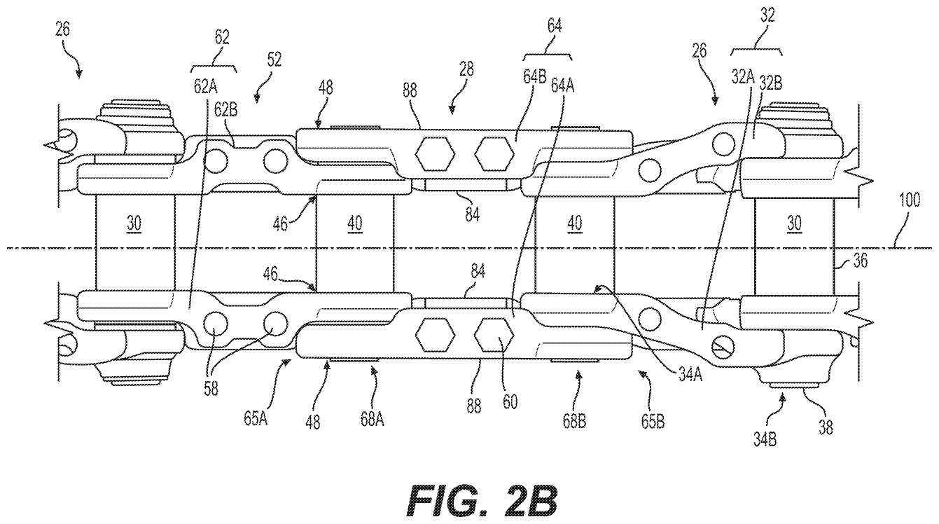

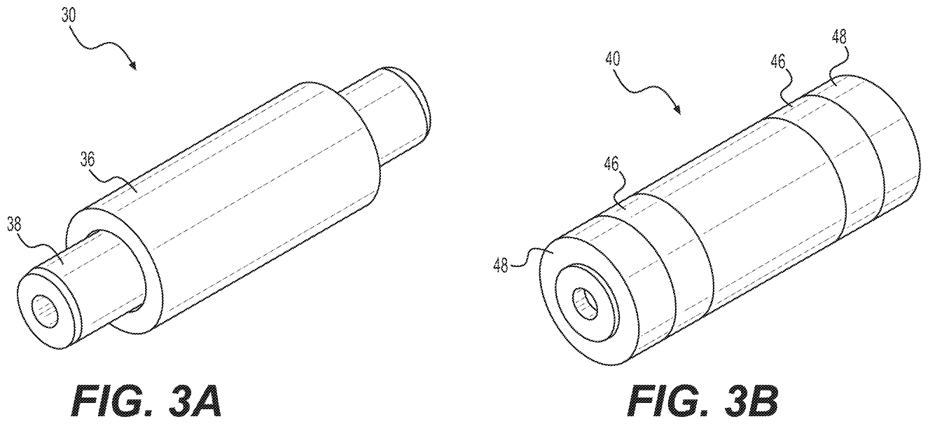

FIGS. 2A and 2B respectively illustrate a perspective view and a top-view of a portion of an exemplary offset link track chain 22. In the discussion below, reference will be made to both FIGS. 2A and 2B. Chain 22 includes a plurality of link subassemblies 26 and a master link assembly 28. A link subassembly 26 of chain 22 includes a pair of laterally spaced apart offset links 32A, 32B each having an aperture (first aperture 34A and second aperture 34B) at their opposite ends. A bushing assembly 30 is used to rotatably couple links 32A, 32B of adjacent link subassemblies 26 together. FIG. 3A illustrates a perspective view of an exemplary bushing assembly 30. Bushing assembly 30 includes a pin 38 rotabably mounted in a hollow bushing 36. In chain 22, adjacent link subassemblies 26 are coupled by a bushing assembly 30 such that the first apertures 34A at an end of a link subassembly 26 forms an interference fit with bushing 36 and the second apertures 34B at the end of an adjacent link subassembly 26 forms an interference fit with pin 38. Rotation of pin 38 in bushing 36 allows the adjacent link subassemblies 26 to rotate relative to each other. Multiple link subassemblies 26 are thus coupled together by bushing assemblies 30 to form an elongate flexible offset link chain having two free ends. Master link assembly 28 couples the two free ends of the elongate chain to form an endless track chain 22 (i.e., a chain that forms an endless loop).

With continued reference to FIGS. 2A and 2B, master link assembly 28 includes a pair of links 64A and 64B that are removably coupled at their opposite ends by cartridge assemblies 40. As best seen in FIG. 2B, unlike offset links 32A and 32B of link subassembly 26, links 64A and 64B of master link assembly 28 are straight links. As known to people skilled in the art, offset links 32A and 32B are shaped such that one end (e.g., end with the first aperture 34A) of the pair of links that form link subassembly 26 are positioned closer to each other (and longitudinal axis 100) that their opposite end (e.g., end with second aperture 34B). In contrast, straight links 64A and 64B of master link assembly 28 are shaped such that the opposite ends of the pair of links are substantially equidistant from each other (and longitudinal axis 100). To transition between the offset links 32A and 32B of link subassemblies 26 (at the free ends of chain 22) and the straight links 64A and 64B of master link assembly 28, a transition link assembly 52 (comprising a pair of straight links 62A and 62B) is coupled between a link subassembly 26 at one end of chain 22 and the master link assembly 28. That is, master link assembly 28 is coupled to a link subassemblies 26 at the free ends of chain 22 via a transition link assembly 52. It should be noted that, in this disclosure, the term “coupled” is used to indicate direct or indirect connection between two components. For example, master link assembly 28 is coupled to link subassemblies 26 indicates that the links of master link assembly 28 are connected to the links of link subassembly 26 directly or indirectly (e.g., via the links of transition link assembly 52).

Links 62A and 62B of transition link assembly 52 are positioned in a mirror symmetric manner about longitudinal axis 100. Similar to links 64A and 64B of master link assembly 28, links 62A and 62B are straight links. That is, links 62A and 62B of transition link assembly 52 are shaped such that their opposite ends are substantially equidistant from each other (and longitudinal axis 100). A top surface of links 62A, 62B (referred to as a shoe surface) incudes fastener holes 58 used to attach a track shoe 24 to transition link assembly 52. Opposite ends of links 62A and 62B include apertures that are used to couple transition link assembly 52 to a link subassembly 26 on one side and master link assembly 28 on the other side. As best seen in FIG. 2B, outer regions of links 62A and 62B that include the apertures are offset from a central region located between these apertures such that, when the pair of links 62A, 62B are arranged to form transition link assembly 52, the apertures of both links are positioned closer together than the central region. Links 62A and 62B also include a plurality of openings in the central region (e.g., to reduce the weight of the links). In some embodiments, links 62A and 62B are shaped substantially similar to the inner links of a straight link track chain. Embodiments of inner links that may be used as links 62A and 62B of transition link assembly 52 are described in U.S. Pat. Nos. 6,382,742 and 7,877,977, that are incorporated by reference in their entireties herein.

With reference to FIGS. 2A and 2B, to rotatably couple transition link assembly 52 between a link subassembly 26 (at a free end of chain 22) and master link assembly 28, the apertures (on links 62A and 62B) at one end of transition link assembly 52 have an interference fit with the bushing 36 of a bushing assembly 30 and the apertures (e.g., second apertures 34B) at the end of the link subassembly 26 are interference fitted to the pin 38 of the bushing assembly 30. Master link assembly 28 is then coupled between the free ends of transition link assembly 52 and the link subassembly 26 at the other free end of chain 22 using two cartridge assemblies 40.

FIG. 3B is a perspective view of an exemplary cartridge assembly 40. Cartridge assembly 40 may include a pair of bearings 46 rotatably mounted about a pin (not marked in FIG. 3B). A pair of collars 48 are fixed at either end of the pin. In cartridge assembly 40, bearing 46 and collar 48 can rotate relative to each other. Exemplary cartridge assemblies that may be used in chain 22 of the current disclosure are described in U.S. Pat. No. 6,382,742, incorporated by reference in its entirety herein. Master link assembly 28, transition link assembly 52, and link subassembly 26 are coupled to cartridge assemblies 40 such that the links on either side of a cartridge assembly 40 can rotate relative to each other about the cartridge assembly 40. However, while the transition link assembly 52 and the link subassembly 26 are fixedly coupled (e.g., by an interference fit) to cartridge assembly 40, the master link assembly 28 is removably coupled to the cartridge assembly 40. That is, as will be explained in more detail below, the links 64A and 64B of the master link assembly 28 can be separated from the cartridge assemblies 40 at either end to disassemble or open chain 22 (e.g., transform chain 22 from an endless loop to a chain with two free ends).

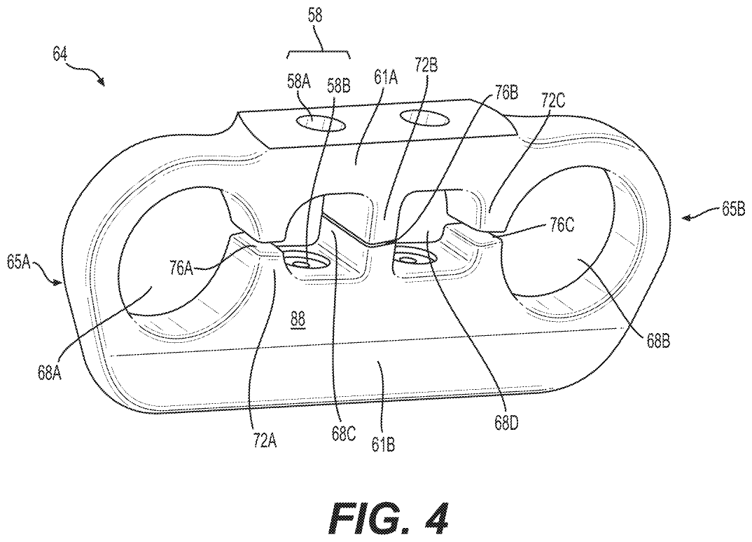

As explained previously, master link assembly 28 includes a pair of straight links 64A and 64B coupled at either end to cartridge link assemblies 40. The configuration (shape, size, etc.) of each link 64A, 64B may be substantially the same. Therefore, unless it is useful to identify the individual links, links 64A and 62B will be jointly referred to as master link 64. FIG. 4 is a perspective view of master link 64 showing its outer surface. In the discussion below, reference will be made to FIGS. 2A, 2B and 4. Master link 64 includes an elongate body that extends from a first end 65A to a second end 65B along longitudinal axis 100. Similar to the links of link assembly 26 and transition link assembly 52, master link 64 includes a shoe surface having fastener holes 58 to attach a track shoe 24 to the master link assembly 28. Links 64A and 64B each include an inner surface 84 that faces each other and an outer surface 88 positioned opposite inner surface 84. As best seen in FIG. 2B, since links 64A and 64B are straight links, when they are assembled to form master link assembly 28, the first and second ends 65A, 65B of links 64A and 64B are spaced substantially equidistant from each other and longitudinal axis 100.

Master link 64 includes a first aperture 68A at its first end 65A, a second aperture 68B at its second end 65B, and a plurality of additional apertures (e.g., two apertures 68C and 68D shown in the figures) positioned between the first and second apertures 68A, 68B. It should be noted that two additional apertures is not a requirement. In some embodiments, a different number (e.g., 1, 3, 4, etc.) of apertures may be provided between the first and second apertures 68A, 68B. Apertures 68C and 68D may assist in reducing the weight of master link 64. Each of apertures 68A-68D extend between the outer and inner surfaces 88, 84 of master link 64 to define through-hole cavities on the link. Apertures 68A-68D are arranged along the length of master link 64 such that a strut 72A (or a strip of material) separates apertures 68A and 68C, a strut 72B separates aperture 68C and 68D, and a strut 72C separates apertures 68D and 68B. In general, the shape of struts 72A, 72B, 72C depend on the shape of the apertures on either side of the strut. In some embodiments, first and second apertures 68A, 68B may have a substantially circular shape and apertures 68C, 68D may have a different shape (e.g., a generally rectangular shape with rounded corners). However, these shapes are only exemplary. In general, these apertures may have any shape (such as, for example, oval, circular, elliptical, square, etc.). In master link 64, apertures 68A-68D delineate or define an upper portion 61A above these apertures and a lower portion 61B below these apertures.

In some embodiments, fastener holes 58 are located above apertures 68C and 68D such that a fastener 60 in these fastener holes 28 pass through the apertures. Fastener holes 58 extend through the upper portion 61A and into the lower portion 61B of master link 64 across apertures 68C and 68D. That is, fastener holes 58 include a first portion 58A that extends through the upper portion 61A and a second portion 58B that extends into the lower portion 61B of master link 64. First and second portions 58A and 58B of a fastener hole 58 may be threaded and configured to receive portions of fastener 60. In the discussion that follows, unless it is useful to identify them separately, first and second portions 58A, 58B of fastener hole 58 will be collectively referred as fastener hole 58. Fasteners 60 in fastener holes 58 of master link 64 may be used to attach a track shoe 24 to master link assembly 28. When fasteners 60 are tightened into fastener holes 58 of master link 64, a portion of the fasteners 60 extend through apertures 68C and 68D into the lower portion 61B of the link body (i.e., into second portion 58B of fastener holes 58) across the aperture (see FIG. 2A). In should be noted that although the links of transition link assembly 52 and link subassembly 32 also include fastener holes 58, the fastener holes 58 in these links may only extend through the upper portion of the link into the aperture (i.e., these fastener holes may not extend into the body of the link below the apertures).

When first end 65A of master link 64 is coupled to transition link assembly 52 via cartridge assembly 40 (see FIGS. 2A and 2B), the inner surface of first aperture 68A of master link 64 will interface with the collar 48 of the cartridge assembly 40, and the aperture at the coupled end of the transition link assembly 52 will form an interference fit with the bearing 46 of the cartridge assembly 40. Similarly, when second end 65B of the master link 64 is coupled to link subassembly 26 via a cartridge assembly 40, the inner surface of second aperture 68B of the master link 64 will interface with the collar 48, and aperture 34A at the coupled end of the link subassembly 26 will form an interference fit with the bearing 46 of the cartridge assembly 40. The size (e.g. diameter) of the first and second apertures 68A, 68B of master link 64 may be configured to accommodate collars 48 of the cartridge assemblies 40 on either side of the master link 64. Although first and second apertures 68A and 68B can have different sizes (e.g., diameters), in some embodiments, both first and second apertures 68A, 68B have the same diameter. In the discussion below, first and second apertures 68A and 68B are assumed to have the same diameter. Master link 64 has a generally planar shape. As best seen in FIG. 2B, when links 64A and 64B are arranged to form master link assembly 28, first and second apertures 68A, 68B of the two links are positioned further apart from each other than a central region of each link between the apertures. Although not described in detail herein, outer and inner surfaces 88, 84 of master link 64 may be contoured to receive correspondingly shaped regions of links that it interfaces with when assembled on chain 22.

With reference to FIGS. 2A and 4, in master link 64, a gap 76A extends through strut 72A between apertures 68A and 68C, a gap 76B extends through strut 72B between apertures 68C and 68D, and a gap 76C extends through strut 72C between apertures 68D and 68B. These gaps 76A, 76B, and 76C connect the apertures on either side of a strut through the body of the link. Gaps 76A, 76B, 76C extend completely through a strut between the inner and outer surfaces 84, 88 of master link 64 to divide the strut into two parts (e.g., an upper section above the gap and a lower section below the gap). For example, gap 76A divides strut 72A that extends between apertures 68A and 68C into two sections (an upper section connected to upper portion 61A and a lower section connected to lower portion 61B), gap 76B divides strut 72B into an upper section connected to upper portion 61A and a lower section connected to lower portion, and gap 76C divides strut 72C into upper and lower sections. In general, gaps 76A, 76B, and 76C may have same or different sizes (e.g., gap thickness). In some embodiments, the thickness of gap 76B may be smaller than the thicknesses of gaps 76A and 76C. In some embodiments, gap 76B may be between about 0.25-2 millimeters (mm) thick (e.g., about 1 mm thick, about 0.75 mm thick, about 0.5 mm thick, etc.), and gaps 76A and 76C may have any thickness greater than the thickness of gap 76B.

Prior to the application of a load (e.g., via fasteners 60 as described below), the natural rigidity of the link body may keep the upper and lower portions 61A and 61B spaced apart from each other, and maintain the gaps 76A-76C at their maximum values. When a fastener 60 is inserted and tightened into the first and second portions 58A, 58B of a fastener hole 58 (for example, to attach a track shoe 24 to master link assembly 28), the fastener 60 may apply a force to urge the upper and lower portions 61A, 61B of master link 64 closer to each other. That is, a compressive force on master link 64. Due to this force, the natural rigidity of the link body may be at least partly overcome, and the upper and lower portions 61A, 61B may come closer towards each other and reduce the width of gaps 76A-76C. As the width of gaps 76A-76C decreases, the diameter of first and second apertures 68A, 68B also decrease. The size (e.g., thickness, etc.) of master link 64 may be such that, fasteners 60 can overcome the rigidity of the link body and urge the upper and lower portions 61A, 61B of the link body towards one another. Gaps 76A-76C may be configured (e.g., sized) such that the diameters of the first and second apertures 68A, 68B decrease from a higher value to a lower value when the upper and lower portions 61A, 61B of master link 64 are urged towards each other by fasteners 60. When fasteners 60 are loosened or removed (e.g., removed from second portion 58B of fastener hole 58), the diameter of first and second apertures 68A, 66B return to their original values.

First and second apertures 68A, 68B may be configured such that, when the upper and lower portions 61A, 61B of master link 64 are urged towards each other by fasteners 60, the diameter of the first and second apertures 68A, 68B reduces to a value substantially equal to, or slightly smaller than, the diameter of the collar 48 (of the cartridge assemblies 40) that each aperture interfaces with. For example, prior to tightening the fasteners 60 on fastener holes 58, the diameter of the first and second apertures 68A, 68B may be larger than the diameter of the collars 48. While in this configuration, links 64A and 64B of master link assembly 28 may be removed (or pulled out) from the cartridge assemblies 40. Note that even when fasteners 60 are removed from links 64A, 64B, links 62A and 62B of the adjacent transition link assembly 52 and links 32A and 32B of the adjacent link subassembly 26 remain attached to the cartridge assemblies 40 because they have an interference fit with the cartridge assemblies 40. When the fasteners 60 are tightened on fastener holes 58 of master link 64, the diameter of the first and second apertures 68A, 68B decreases such that the inner surfaces of the first and second apertures 68A, 68B tightly clamp on the outer surfaces of the collars 48 of the cartridge assemblies 40 in these apertures. In this configuration, the two ends of master link 64 are tightly coupled to the cartridge assemblies 40 on either side. When the fasteners 60 are loosened or removed, the first and second apertures 68A, 68B return to their original diameter and allow the master link 54 to be removed from the cartridge assemblies 40.

In embodiments where the size of gap 76B is smaller than gaps 76A and 76C, the size of gap 76B may limit the movement of the upper and lower portions 61A, 61B towards each other, and the amount by which the diameter of first and second apertures 68A, 68B decreases. For example, in an exemplary embodiment where gap 76B is about 0.75 mm thick (and gaps 76A and 76C are thicker), the maximum decrease in diameter of first and second apertures 68A, 68B will also be about 0.75 mm. Since the amount of clamping force generated by the inner walls of the first and second apertures 68A, 68B on collar 48 (of cartridge assembly 40) is related to the diameter of these apertures, the size of gap 76B may affect the amount of clamping force acting on cartridge assembly 40. Since a single gap (i.e., gap 76B) controls the clamping force, machining tolerance requirements of the other gaps (i.e., gaps 76A and 76C) may be lower, thus reducing cost. For example, only gap 76B will have to be machined with a tight tolerance. In general, gap 76B may be sized so that first and second apertures 68A, 68B generate sufficient clamping force to couple to the cartridge assemblies 40 in these apertures 68A, 68B.

In general, master link 64 (and link 62) may be made from any material known in the art having enough stiffness to keep the upper and lower portions of the master link separated without a biasing force and to enable the upper and lower portions to be urged towards each other by fasteners 60. In addition, the material may be durable to withstand repeated use. Although not a requirement, in some embodiments, master link 64 and link 62 may be made from a carbon steel such as a 15B34 carbon steel. In some embodiments, links 62, 64 (or portions thereof) may be covered with a protective coating to shield the links from the environment in which machine 10 may be operating. Although not a requirement, in some embodiments, fasteners 60 may be made from the same material as master link 64.

It should be noted that, although master link 64 is illustrated as having two apertures 68C and 68D positioned between first and second apertures 68A and 68B, and one fasteners 60 extending through each aperture, this is only exemplary. In some embodiments, a different number of fasteners may extend through each aperture. In some embodiments, a different number of apertures may be provided between first and second apertures 68A and 68B. For example, in some embodiments, master ink 64 may have only one aperture (e.g., third aperture) between first and second apertures 68A and 68B and a gap that extends through the link body from the third aperture to each of first and second apertures 68A and 68B. And, one or more (e.g., two fasteners) may extend through the third aperture to compress master link 64 and change the width of the gaps (and thereby first and second apertures 68A and 68B).

### Industrial Applicability

The disclosed master link assembly 28 may be applicable to any tracked machine 10 having an offset link track chain 22. The disclosed masker link assembly enables the track chain 22 to be easily and quickly disassembled thereby reducing maintenance cost and machine down time.

An exemplary method of assembling and disassembling a track chain 22 will now be described. To connect the two free ends of track chain 22 together using master link assembly 28, a transition link assembly 52 having a pair of straight links 62 is coupled to one free end of chain 22 using a bushing assembly 30. Master links 64 of master link assembly 28 are then coupled between the free end of transition link assembly 52 and the other free end of chain 22 via cartridge assemblies 40. Cartridge assembles 40 coupled via an interference fit to the apertures at the two free ends such that these apertures are fixedly connected to the bearings 46 of the cartridge assemblies 40. Master links 64 of the master link assembly 28 are then removably coupled between the two cartridge assemblies 40.

When coupling master links 64 to cartridge assemblies 40 on either side, fasteners 60 are loosened or removed from these links. With the fasteners 60 removed, gaps 76A-76C of master links 64 may be at their maximum thickness or size. Consequently, the first and second apertures 68A, 68B of master link 64 may be at their maximum diameter (i.e., first value of diameter). Master links 64 are then be positioned such that the collars 48 of the cartridge assembles 40 are positioned within their first and second apertures 68A, 68B. In this configuration, since the diameter of the first and second apertures 68A, 68B is greater than the outer diameter of the collars 48, the first and second apertures 68A, 68B of the master links 64 will fit around the collars 48. Track shoes 24 may now be secured to the master link assembly 28 by inserting fasteners 60 into fastener holes 58 on the master links 64. As each fastener 60 is tightened, portions of the fastener 60 engage with first and second portions 58A, 58B of the fastener holes 58, and urge the upper and lower portions 61A, 61B of the master link 64 towards each other (i.e., compressing master link 64). As the upper and lower portions move toward each other, the widths of gaps 76A-76C decrease. As these widths decrease, the diameter of the first and second apertures 68A, 68B decreases causing the inner surfaces of these apertures to clamp on, and tightly couple to, the cartridge assemblies 40 positioned within these apertures.

To separate chain 22, fasteners 60 are loosened (or removed from second portion 58B of fastener holes 58) from master links 64. When fasteners 60 are loosened, the diameter of the first and second apertures 68A, 68B returns to their original larger value, and the master links 64 may be removed from the cartridge assemblies 40. Providing a master link assembly 28 that may be easily decoupled to separate track chain 22 enables the chain 22 to be quickly disassembled, and thus reduces machine down time and maintenance cost. Using a master link assembly with straight links for an offset link chain enables components of a straight link chain to be used with an offset link chain, thereby reducing the number of separate components that have to be inventoried and reduce cost.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. An offset link track chain, comprising:
a plurality of link subassemblies including a first link subassembly and a second link subassembly, each link subassembly of the plurality of link subassemblies including a pair of offset links coupled together; and
a master link assembly removably coupled between the first link subassembly and the second link subassembly, wherein the master link assembly includes a pair of straight links, and wherein each straight link of the pair of straight links includes a link body having (a) a first aperture positioned proximate a first end, (b) a second aperture positioned proximate a second end, and (c) a threaded fastener, wherein changing a relative position of the fastener with respect to the link body changes a diameter of the first and second apertures.

2. The offset link track chain of claim 1, further including a third aperture positioned between the first and second apertures, wherein the fastener extends into the link body through the third aperture.

3. The offset link track chain of claim 2, further including a first gap extending through the link body between the first and third apertures and a second gap extending through the link body between the second and third apertures.

4. The offset link track chain of claim 3, wherein changing the relative position of the fastener with respect to the link body changes a thickness of the first and second gaps.

5. The offset link track chain of claim 1, further including a third aperture and a fourth aperture positioned between the first and second apertures, a first gap extending through the link body between the third and fourth apertures, a second gap extending through the link body between the first and third apertures, and a third gap extending through the link body between the second and fourth apertures.

6. The offset link track chain of claim 5, wherein a thickness of the first gap is smaller than a thickness of the second and third gaps.

7. The offset link track chain of claim 6, wherein a thickness of the first gap is between about 0.25-2 millimeters.

8. The offset link track chain of claim 5, wherein the threaded fastener is a first fastener extending into the link body through the third aperture and further including a threaded second fastener extending into the link body though the fourth aperture.

9. The offset link track chain of claim 1, further including a transition link assembly coupled between the first link subassembly and the master link assembly, wherein the transition link assembly includes a pair of straight links coupled at one end to the pair of offset links of the first link subassembly and coupled at an opposite end to a first cartridge assembly, the first end of the pair of straight links of the master link assembly being removably coupled to the first cartridge assembly.

10. The offset link track chain of claim 9, wherein the first cartridge assembly is positioned in the first aperture of the pair of straight links of the master link assembly.

11. The offset link track chain of claim 9, wherein the second end of the pair of straight links of the master link assembly is removably coupled to a second cartridge assembly, and the pair of offset links of the second link subassembly is fixedly coupled to the cartridge assembly.

12. An offset link track chain, comprising:
a plurality of link subassemblies including a first link subassembly and a second link subassembly, each link subassembly of the plurality of link subassemblies including a pair of offset links coupled together; and
a master link assembly removably coupled between the first link subassembly and the second link subassembly, wherein the master link assembly includes a pair of straight links, and wherein each straight link of the pair of straight links includes a link body having (a) a first aperture positioned proximate a first end, (b) a second aperture positioned proximate a second end, (c) a third aperture positioned between the first and second apertures, (d) a gap extending through the link body between the first and third apertures, and (e) a threaded fastener extending into the link body through the third aperture.

13. The offset link track chain of claim 12, further including a fourth aperture positioned between the second and third apertures and a second gap extending through the link body between the second and fourth apertures.

14. The offset link track chain of claim 13, further including a third gap extending through the link body between the third and fourth apertures, wherein a thickness of the third gap is less than a thickness of the first and second gaps.

15. The offset link track chain of claim 14, wherein a thickness of the third gap is between about 0.25-2 millimeters.

16. The offset link track chain of claim 12, further including a transition link assembly coupled between the first link subassembly and the master link assembly, wherein the transition link assembly includes a pair of straight links coupled at one end to the pair of offset links of the first link subassembly and coupled at an opposite end to a first cartridge assembly, the first end of the pair of straight links of the master link assembly being removably coupled to the first cartridge assembly.

17. The offset link track chain of claim 16, wherein the second end of the pair of straight links of the master link assembly is removably coupled to a second cartridge assembly, and the pair of offset links of the second link subassembly is fixedly coupled to the cartridge assembly.

18. A method of fabricating an endless offset link track chain, comprising:
fixedly coupling a plurality of link subassemblies together to form an offset link track chain having a first free end and a second free end;
fixedly coupling a transition link assembly to the first free end of the offset link track chain, wherein the transition link assembly includes a pair of straight links; and
removably coupling a master link assembly between the transition link assembly and the second free end of the offset link track chain to form an endless track chain, wherein the master link assembly includes a pair of straight links.

19. The method of claim 18, wherein removably coupling the master link assembly includes (a) removably coupling a first end of the pair of straight links of the master link assembly to a first cartridge assembly, (b) removably coupling a second end of the pair of straight links of the master link assembly to a second cartridge assembly, (c) coupling an end of the pair of straight links of the transition link assembly to the first cartridge assembly, and (d) coupling the second free end of the offset link track chain to the second cartridge assembly.

20. The method of claim 18, wherein each straight link of the pair of straight links of the master link assembly includes a link body having first and second apertures with a variable diameter and a threaded fastener configured to change the diameter of the first and second apertures, the method further removing the threaded fastener from the link body to separate the master link assembly from the transition link assembly and the offset link track chain.
